(19) United States
(12) Patent Application Publication
(10) Pub. No.: US 2020/0078265 A1
(43) Pub. Date: Mar. 12, 2020

(54) Method and Process of Self-Directed Healing of the Mind, Body, and Spirit

(71) Applicant: Dr Alex Loyd Services LLC, Nashville, TN (US)

(72) Inventor: Alex Loyd, Brentwood, TN (US)

(21) Appl. No.: 16/563,786

(22) Filed: Sep. 6, 2019

Related U.S. Application Data
(60) Provisional application No. 62/727,661, filed on Sep. 6, 2018.

(51) Int. Cl. A61H 39/04; A61H 39/08; A47G 33/00

(52) U.S. Cl. CPC A61H 39/04; A61H 39/02; A47G 33/008; A61H 39/08

(57) ABSTRACT

Trilogy method provides a process of self-directed energy healing of mind, body, and spirit of a user to release stress and negative issues. More specifically, the trilogy process is a user self-directed therapy/healing process that combines the most effective therapy modalities. Various modalities derived into the trilogy method include unique healing code points, acupuncture points, meridians, chakra energy centers, governing and conception vessels, eye movement, chi, prayer, meditation, releasing statements, and/or any other viable and suitable modalities that encourage physical, mental, and/or spiritual healing for the user. Additionally, the trilogy method incorporates several self-directed hand/palm movements including tapping, rubbing, pressurizing, and stimulating actions. The trilogy method comprises a three-minute self-directed procedure that uses the most effective modalities. Further, the trilogy method can be supplemented with additional procedures derived from effective but optional modalities that total to a five-minute complete trilogy process.

The current application claims a priority to the U.S. Provisional Patent application Ser. No. 62/727,661 filed on Sep. 6, 2018.

### FIELD OF THE INVENTION

The present invention relates generally to therapy exercises in energy medicine and energy psychology. More specifically, the present invention relates to a self-directed therapy exercise that heals the mind, body and spirit through a series of self-directed therapy/healing exercises, which combines the most effective therapy modalities, and a plurality of prayers to release stress and any negative/unhealthy issues.

### BACKGROUND OF THE INVENTION

In present times, many individuals are torn between juggling heavy workloads, managing relationships and family responsibilities, and squeezing in outside interests, it is no surprise that more than one in four Americans describe themselves as “super stressed” according to an article titled “Mental Health America” by Mental Health America (MHA). “Stress can zap our concentration, make us irritable or depressed, and harm our personal and professional relationships. Over time, stress also weakens our immune systems, and makes us susceptible to a variety of ailments from colds to backaches to heart disease. The newest research shows that chronic stress can actually double our risk of having a heart attack. Not only is achieving a healthy work/life balance an attainable goal but workers and businesses alike see the rewards.” Thus, people are always looking for ways to cope with stress and negative emotions/traits/behaviors. In conventional systems of energy medicine and energy healing therapy, licensed practitioners are often hired by the individuals, resulting in professional, but costly methods of dealing with stress, and negative emotions/traits/behaviors.

In the field of energy medicine and energy psychology, energy, in the form of Chi, Ki, Qi, Prana, Force, is all around us. All living entities—birds, flowers, trees and human beings—are manifestations of energy. Living in a world of energy, people have been tapping on the various energy healing modalities to heal human beings and others for the past thousands of years. In the ancient Egypt, people acquired the knowledge to harness cosmic energy through the pyramids for many purposes including healing. Further, there were many shamans, or energy healers, who were able to heal people through laying of hands, according to an article titled “10 Types of Energy Healing Modalities” by lotus-happiness.com. “All healings are self-healing. Our bodies are endowed with extraordinary abilities to heal ourselves. We are energy and hence it is possible to perform healing for ourselves as well as others.” Energy healing modalities, such as Quantum Touch®, EFT (Emotional Freedom Techniques®), Reiki, acupuncture, yoga, tai chi, etc., are alternative medical therapies based on the movement of energy in the body. Traditionally, there are thousands of modalities, every one of them, however, normally addresses one thing of a human being, such as a physical body part, a mental illness, a specific psychological problem, etc. Many modalities may be great for the physical body but lack the capability to deal with mental and/or spiritual issues of a user. Other modalities may be great for addressing mental issues such as the user's conscious thoughts, feelings, emotions, actions, but do not address the physical and/or spiritual issues the use may have at the same time. Numerous individuals have frustratingly tried one thing after another to look for a whole healing solution to their problems that relate to their physical, mental and spiritual well-being. Generally speaking, there is no modality existed that can address everything of a human being, which consists of body, mind, and spirit.

The present invention, Trilogy, addresses everything of a human being: body, mind, spirit, and in particular, addresses acupuncture points, meridians, memories, brain functioning, governing and conception vessel—the river of energy that flows the user's body, chakras and energy centers, prayer and meditation, etc. Trilogy is a unique process of energy healing that combines the world's top modalities into a single, powerful process and structures them so that they complement and empower one another. Each component addresses the body, mind, or spirit in a different combination, so that when used together, they deliver powerful healing to any problem, regardless of the source. Specifically, the trilogy method addresses four aspects of a human being through energy healing therapy. Firstly, the trilogy method addresses the physical and mental by making use of acupuncture points and meridians. This is the top energy modality in the world, commonly used in well-known practices such as acupuncture, TFT (Thought Field Therapy) and EFT. Secondly, the trilogy method addresses the mental and spiritual, using the Healing Code points to address harmful and wrong beliefs in your memories. The Healing Code points were discovered by Dr. Alexander Loyd and are the second most used energy modality in the world. Thirdly, the trilogy method addresses the spiritual and physical by making use of governing and conception vessels as well as chakra energy centers. Fourthly, the trilogy method addresses the physical, mental and spiritual through meditation, prayer and truth-focused statements.

Overall, the trilogy process of the present invention aims to provide a self-directed approach to cope with stress and negative emotions/traits/behaviors. Specifically, the present invention allows the user to perform quick, easy and effective self-directed exercises that heal the mind, body, and spirit. Additionally, the present invention comprises additional steps that further supplements the aforementioned process. Furthermore, the present invention can be supplemented with the usage of audio, visual devices and recordings to aid in accelerating and enhancing the healing process of the trilogy method of the present invention.

### SUMMARY OF THE INVENTION

Trilogy provides a method and process of self-directed energy healing of mind, body, and spirit of a user to release stress and negative issues. The trilogy method (interchangeable with trilogy process) dealing with everything of a human being: body, mind, spirit, and in particular, addresses unique healing code points, acupuncture points, meridians, memories, brain functioning, governing and conception vessel—the river of energy that flows a user's body, chakra energy centers, prayer and meditation, etc. Trilogy is a unique process of energy healing that weaves the world's top modalities and structures them so that they complement and empower one another. Each component addresses the body, mind, or spirit in a different combination, so that when used together, they deliver powerful healing to any problem, regardless of the source. Using acupuncture points and meridians, the trilogy method addresses the physical and mental issues. With unique Healing Code points, the trilogy method addresses the mental and spiritual issues to transform harmful and wrong beliefs in your memories. By making use of governing and conception vessels as well as chakra energy centers, the trilogy method addresses the spiritual and physical issues. Further, the trilogy method addresses the physical, mental and spiritual through meditation, prayer and truth-focused statements.

Thus, the trilogy method is a user self-directed therapy/healing process to cope with stress and negative emotions/traits/behaviors. The trilogy process incorporates several self-directed hand/palm movements including tapping, rubbing, pressurizing, and stimulating actions. Furthermore, the trilogy process can be conveyed as a series of pictures, videos, words, audio frequencies from an appropriate visual and/or audio device. The trilogy process is preferably a three-minute self-directed procedure that uses the most effective modalities. And the trilogy process can further be supplemented with additional procedures derived from effective but optional modalities that total to a five-minute complete trilogy process.

### BRIEF DESCRIPTION OF THE DRAWINGS

FIG. 1 is a system diagram of the present invention.

FIG. 2 is a flowchart of an overall process for a trilogy method of the present invention.

FIG. 3 is a flowchart of a prayer sub-process for an accupoint exercise of the present invention.

FIG. 4 is a flowchart of a prayer sub-process for a healing code point exercise of the present invention.

FIG. 5 is a flowchart of a prayer sub-process for a governing and conception vessel exercise of the present invention.

FIG. 6 is a flowchart of a sub-process for the accupoint exercise of the present invention.

FIG. 7 is a flowchart of a sub-process for the healing code point exercise of the present invention.

FIG. 8 is a flowchart of an alternative sub-process for the healing code point exercise of the present invention.

FIG. 9 is a flowchart of a sub-process for the governing and conception vessel exercise of the present invention.

FIG. 10 is a flowchart of additional sub-processes for the trilogy method of the present invention.

FIG. 11 is a flowchart of an energy balance exercise sub-process for the trilogy method of the present invention.

FIG. 12 is a flowchart of a miracle minute exercise sub-process for the trilogy method of the present invention.

FIG. 13 is a flowchart of a releasing statement exercise sub-process for the trilogy method of the present invention.

FIG. 14 is a flowchart of a sub-process of the trilogy method for providing and maintaining a relaxed healing environment using an audio and visual system of the present invention.

FIG. 15 is a diagram of a plurality of accupoints used in the accupoint exercise of the present invention.

FIG. 16 is a diagram of a plurality of healing code points used in the healing code point exercise of the present invention.

FIG. 17 is a diagram of a plurality of governing and conception vessel paths used in the governing and conception vessel exercise of the present invention.

FIG. 18 is a diagram of a plurality of chakra energy centers used in the governing and conception vessel exercise of the present invention.

FIG. 19 is a bar chart and data table illustrating heart rate variability test results of the trilogy method of the present invention.

FIG. 20 is a bar chart and data table illustrating pulse rate test results of the trilogy method of the present invention.

FIG. 21 is a bar chart and data table illustrating emotional rating of issue test results of the trilogy method of the present invention.

### DETAIL DESCRIPTIONS OF THE INVENTION

All illustrations of the drawings are for the purpose of describing selected versions of the present invention and are not intended to limit the scope of the present invention.

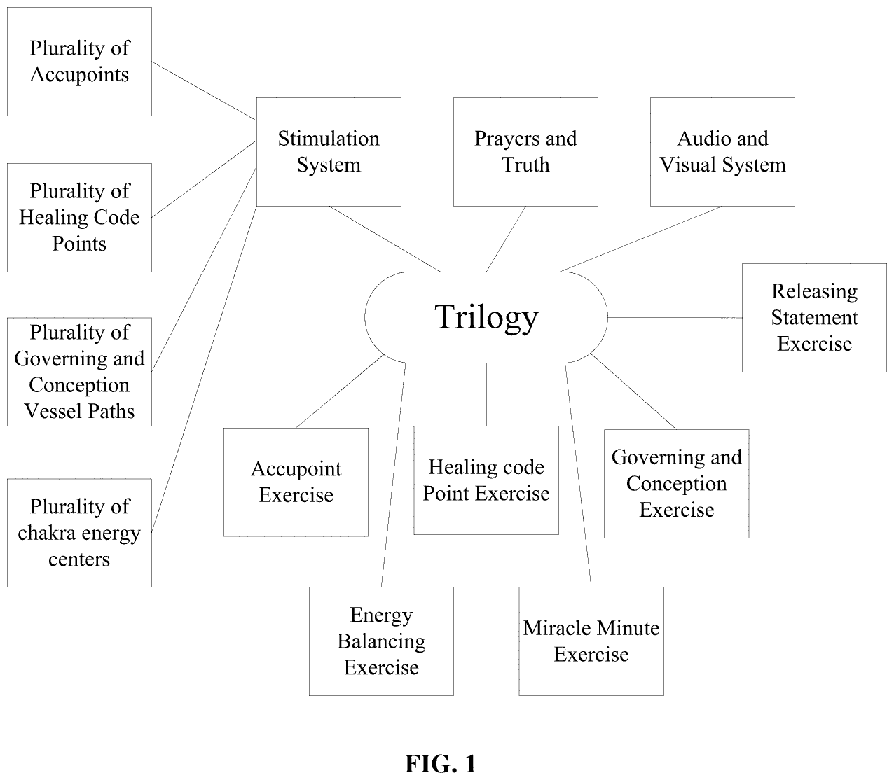

As can be seen in FIG. 1 to FIG. 21, the present invention, called “Trilogy,” comprises a method and process of self-directed energy healing of mind, body, and spirit of a user to release stress and negative issues. More specifically, the trilogy process is a user self-directed therapy/healing process that combines the most effective therapy modalities. Various modalities derived into the trilogy process including, but not limited to, acupuncture points, meridians, chakras, governing and conception vessels, eye movement, chi, prayer, meditation, and/or any other viable and suitable modalities that encourage physical, mental, and/or spiritual healing for the user. Additionally, the trilogy process incorporates several self-directed hand/palm movements including tapping, rubbing, pressurizing, and stimulating actions. Furthermore, the trilogy process can be conveyed as a series of pictures, videos, words, audio frequencies from an appropriate visual and/or audio device. In the preferred embodiment of the present invention, the trilogy process is a three-minute self-directed procedure that uses the most effective modalities. In other embodiments of the present invention, the trilogy process can further be supplemented with additional procedures derived from effective but optional modalities that total to a five-minute complete trilogy process.

As can be seen in FIG. 1, the trilogy method of the present invention comprises a stimulation system, prayers and truth, an audio and visual system, an accupoint exercise, a healing code point exercise, a governing and conception exercise, an energy balancing exercise, a miracle minute exercise, and a releasing statement exercise. Additionally, the stimulation system comprises a plurality of accupoints used in the accupoint exercise, a plurality of healing code points used in the healing code point exercise, and a plurality of governing and conception vessel paths used in the governing and conception exercise. The prayers and truth may be used at the beginning of each of the exercises and the prayers are directed to the specific purpose and focus of the specific exercise when start the exercise. Further, the trilogy method comprises the audio and visual system that provides and maintains a relaxed healing environment for the user to perform the trilogy method of the present invention. More specifically, the audio and visual system includes, but is not limited to, a plurality of audio recordings, a plurality of images, a plurality of videos, and any combination thereof. Through this audio and visual system, the trilogy method can offer a combination of audio recordings, imagery, and video that the user can use anytime, anywhere to reset the user's vibrational frequencies. The sound waves, words, images, and phrases are meticulously designed and scientifically proven to facilitate relaxation and eliminate stress from the user's body. In one embodiment of the present invention, the trilogy system may include multiple (for instance, 12) custom-engineered digital wave frequency recordings, audio recordings designed to fully optimize the user's vibrational frequencies to tune into perfect health, relaxation, peace, and joy. In another embodiment of the present invention, the trilogy system may include multiple (for instance, seven) custom-engineered Trifecta visual and sound wave frequency combination, subtle, custom designed imagery that offers the user the perfect alignment of imagery, power words, and sound waves in video format. In yet another embodiment of the present invention, the trilogy system may include recorded audio coaching sessions, a step-by-step blueprint showing the user exactly how to use and fully benefit from the present invention.

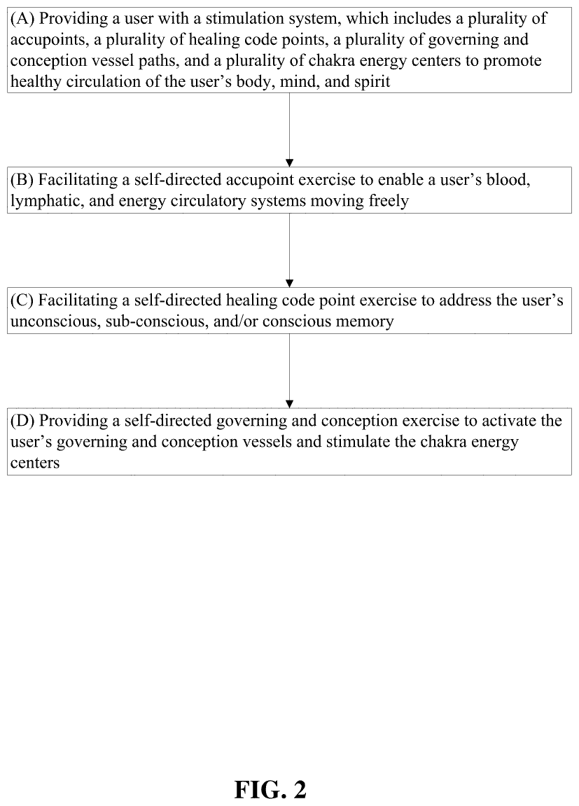

As can be seen in FIG. 2, the overall process of the trilogy method of the present invention starts with providing the user with the stimulation system, which includes the plurality of accupoints, a plurality of healing code points, a plurality of governing and conception vessel paths, and a plurality of chakras energy centers to promote healthy circulation of the user's body, mind, and spirit (Step A). Then the trilogy method facilitates a self-directed accupoint exercise to enable a user's blood, lymphatic, and energy circulatory systems moving freely (Step B). Subsequently, the trilogy method Facilitates a self-directed healing code point exercise to address the user's unconscious, sub-conscious, and/or conscious memory (Step C). Further, the trilogy method Providing a self-directed governing and conception exercise to activate the user's governing and conception vessels and stimulate the chakras energy centers (Step D). The overall process serves as the core of the trilogy method that can universally apply to any user. In the preferred embodiment of the present invention, the overall process lasts a duration including, but not limited to, about three minutes.

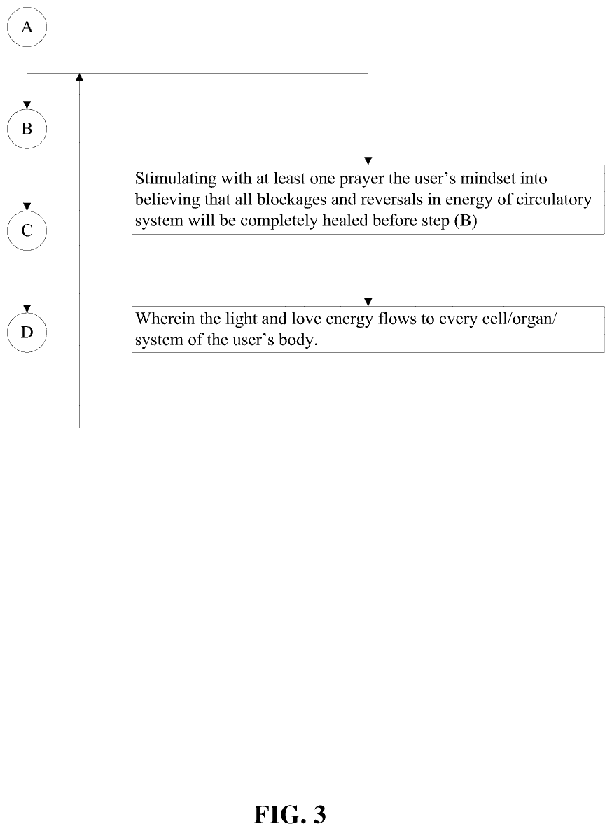

As can be seen in FIG. 3, the trilogy method of the present invention provides a sub-process to the user for praying at the beginning of the self-directed accupoint exercise. More specifically, the trilogy method stimulates with at least one prayer the user's mindset into believing that all blockages and reversals in energy of circulatory system will be completely healed before Step B, wherein the light and love energy flows to every cell/organ/system of the user's body. The prayers are incorporated within each exercise of the trilogy process. More specifically, the prayers are a series of positive mental initiatives used throughout the trilogy process.

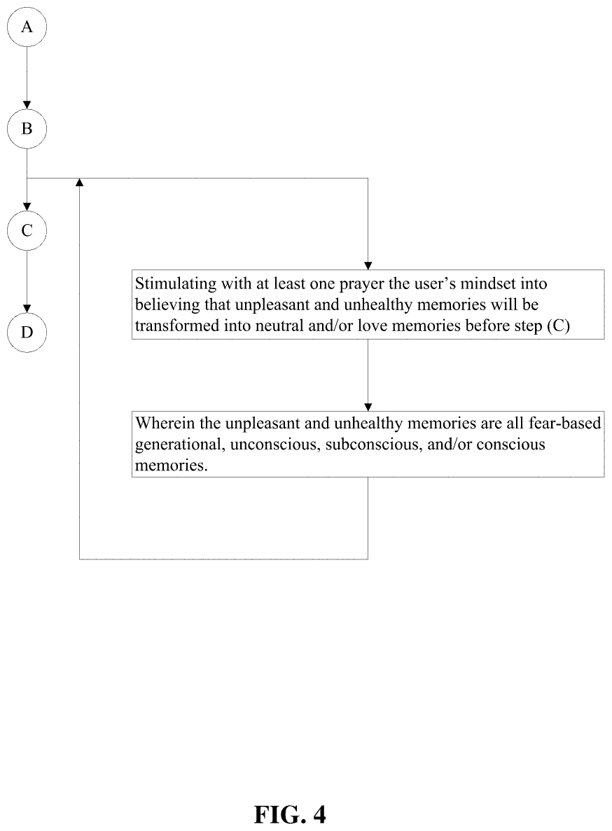

As can be seen in FIG. 4, the trilogy method of the present invention provides a sub-process to the user for praying at the beginning of the self-directed healing code point exercise. More specifically, the trilogy method stimulates with at least one prayer the user's mindset into believing that unpleasant and unhealthy memories will be transformed into neutral and/or love memories before Step C, wherein the unpleasant and unhealthy memories are all fear-based generational, unconscious, subconscious, and/or conscious memories.

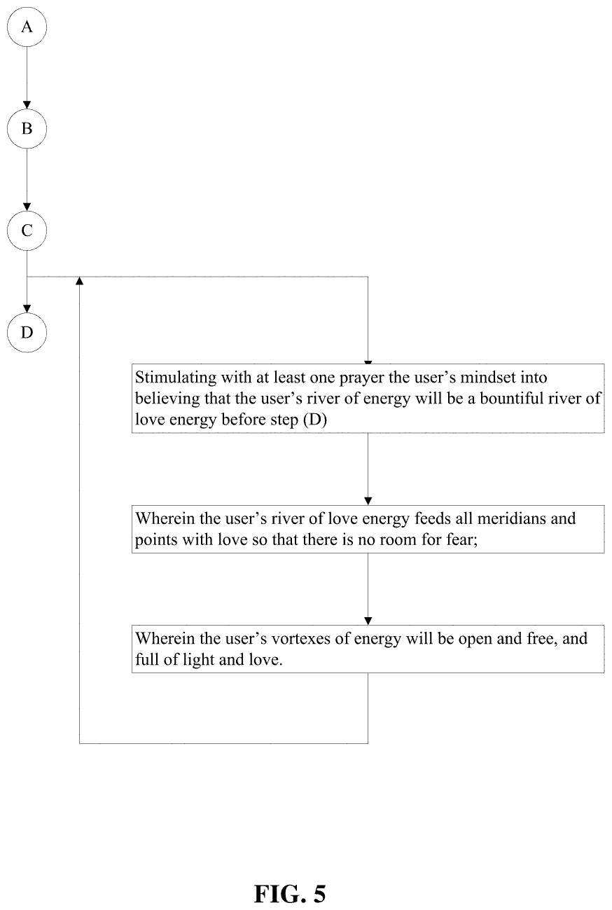

As can be seen in FIG. 5, the trilogy method of the present invention provides a sub-process to the user for praying at the beginning of the self-directed governing and conception exercise. More specifically, the trilogy method stimulates with at least one prayer the user's mindset into believing that the user's river of energy will be a bountiful river of love energy before Step D, wherein the user's river of love energy feeds all meridians and points with love so that there is no room for fear, and wherein the user's vortexes of energy will be open and free, and full of light and love.

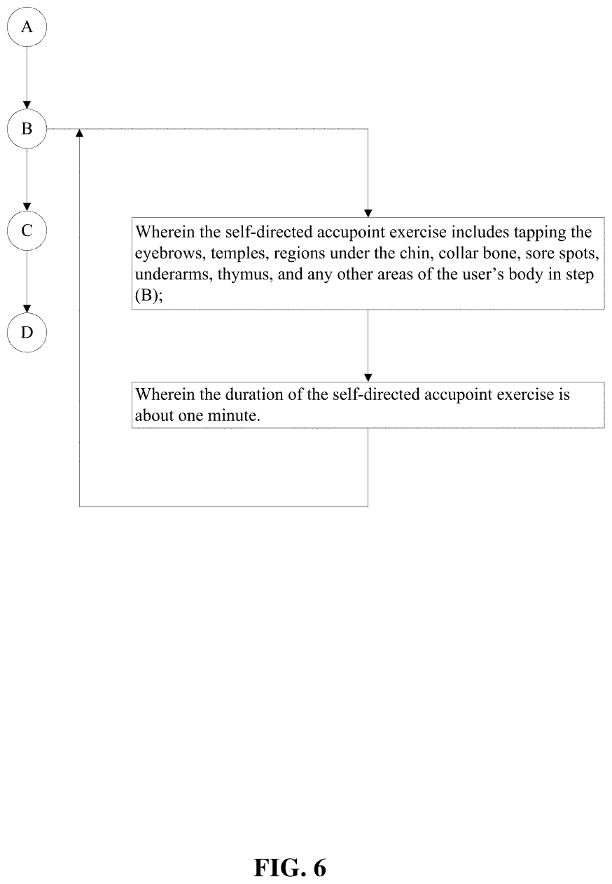

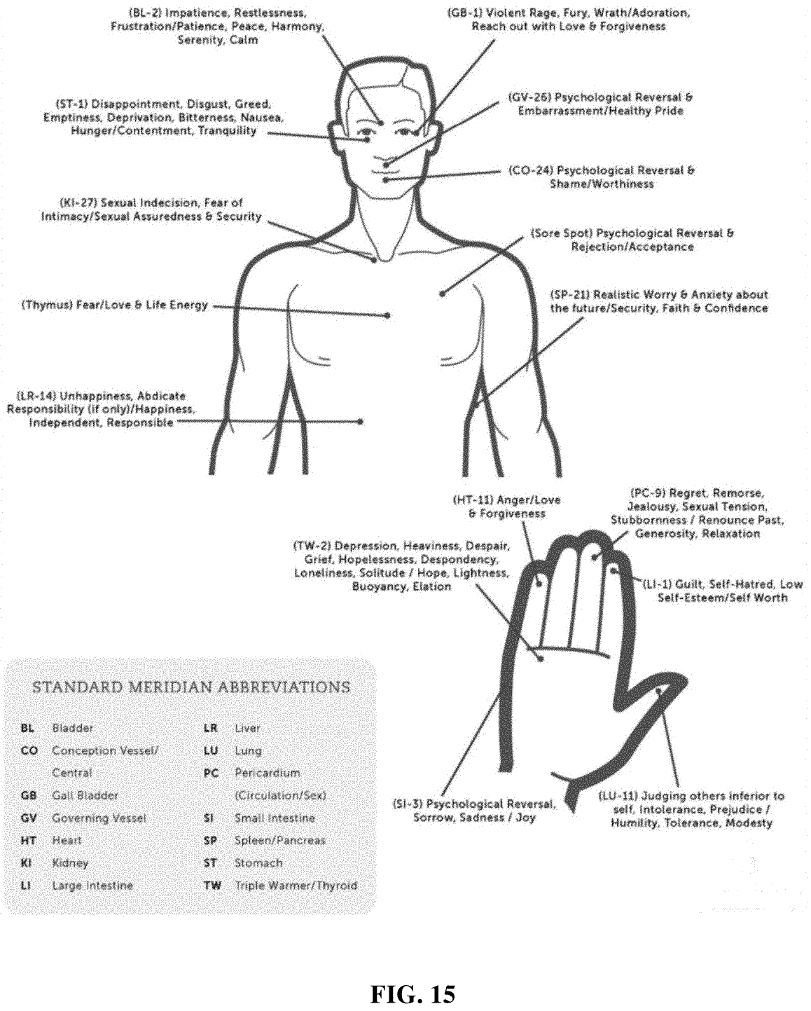

As can be seen in FIG. 6, the trilogy method of the present invention provides a sub-process to the user for facilitating the self-directed accupoint exercise. More specifically, the trilogy method enables the user to perform the self-directed accupoint exercise by tapping the eyebrows, temples, regions under the chin, collar bone, sore spots, underarms, thymus, and any other areas of the user's body in Step B, wherein the duration of the self-directed accupoint exercise is about one minute. As seen in FIG. 15, the user taps the areas including, but not limited to, the eyebrows, temples, regions under the chin, collar bone, sore spots, underarms, thymus, and any other areas of the user's body to exercise the user's blood, lymphatic, and energy circulatory systems. The first phase promotes healthy circulation of the user's mind, spirit and body, as well as the reversal of negative emotions/traits/behaviors.

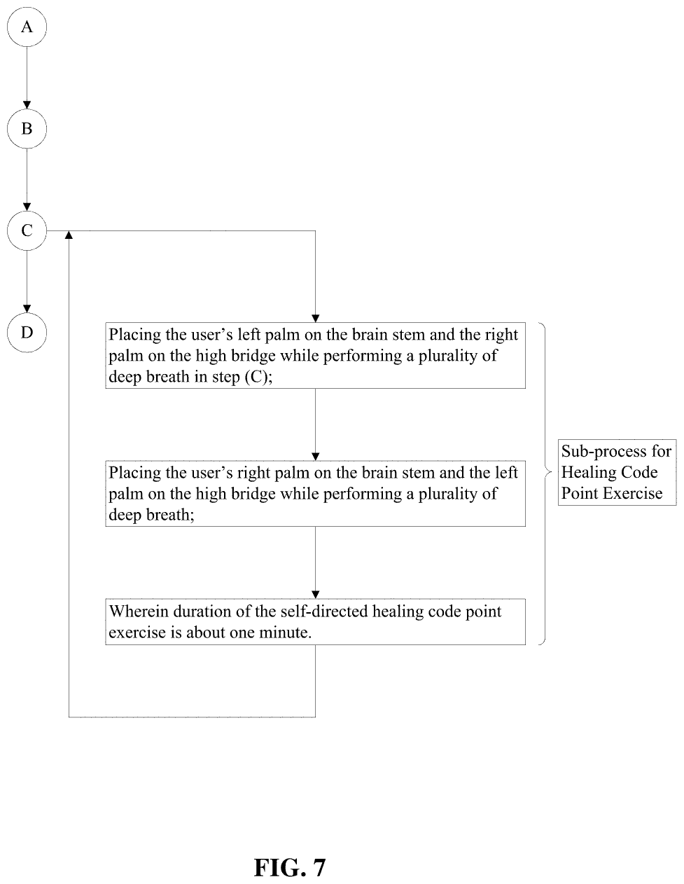

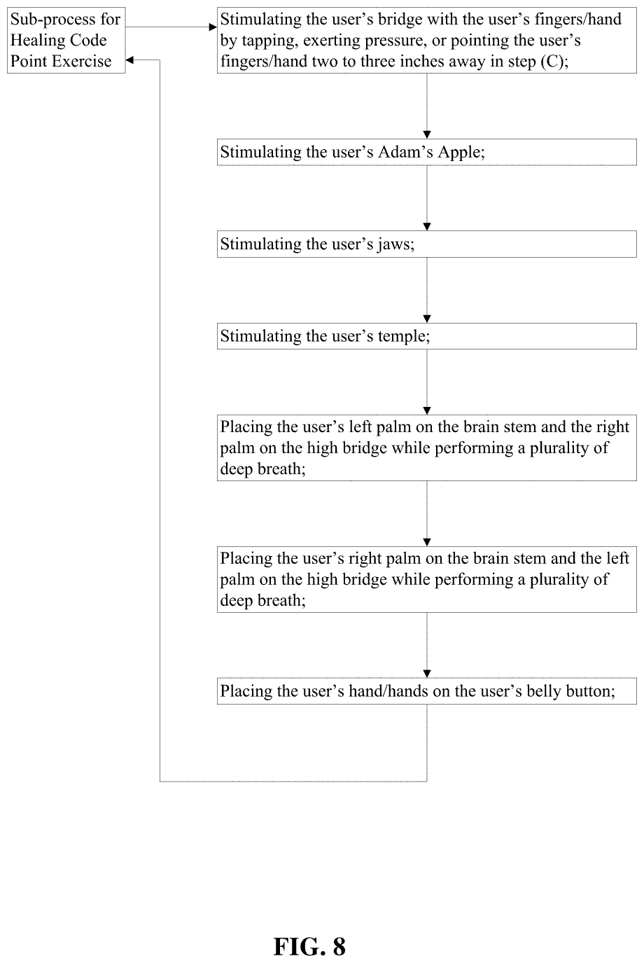

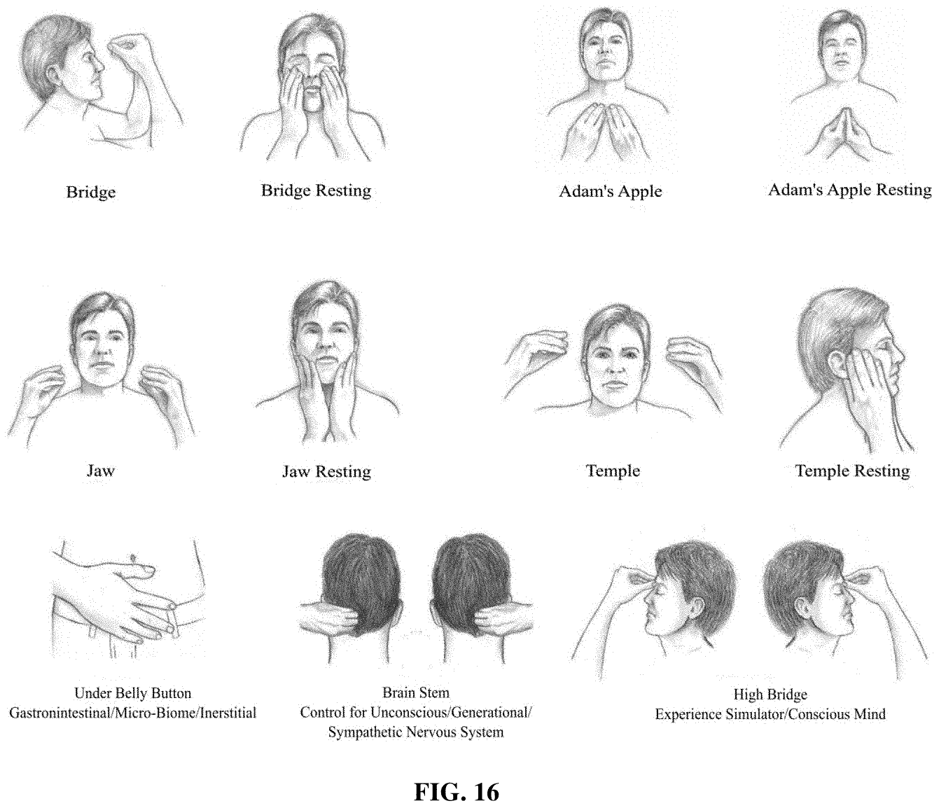

As can be seen in FIG. 7, the trilogy method of the present invention provides a sub-process to the user for facilitating the self-directed healing code point exercise. The healing code point exercise sub-process incorporates hand position healing codes to address the unconscious, sub-conscious, and/or conscious memories of the user. More specifically, the trilogy method enables the user to place the user's left palm on the brain stem and the right palm on the high bridge while performing a plurality of deep breath in Step C, then switch the palms by placing the user's right palm on the brain stem and the left palm on the high bridge while performing a plurality of deep breath, wherein duration of the self-directed healing code point exercise is about one minute. The trilogy method of the present invention is not limited to the aforementioned exercise sequence. As can be seen in FIG. 16, the trilogy method of the present invention stimulates the user's healing code points including, but not limited to, brain stem, high bridge, bridge, Adam's Apple, jaw/jaws, temple, belly button. In another embodiment of the present invention, as can be seen in FIG. 8, the trilogy method enables the user to stimulate the user's bridge with the user's fingers/hand by tapping, exerting pressure, or pointing the user's fingers/hand two to three inches away in Step C, then stimulates the user's Adam's Apple, the user's jaws, the user's temple, then, placing the user's left palm on the brain stem and the right palm on the high bridge while performing a plurality of deep breath, placing the user's right palm on the brain stem and the left palm on the high bridge while performing a plurality of deep breath, and subsequently, placing the user's hand/hands on the user's belly button. The trilogy method of the present invention, however, is not limited to the aforementioned exercise sequence.

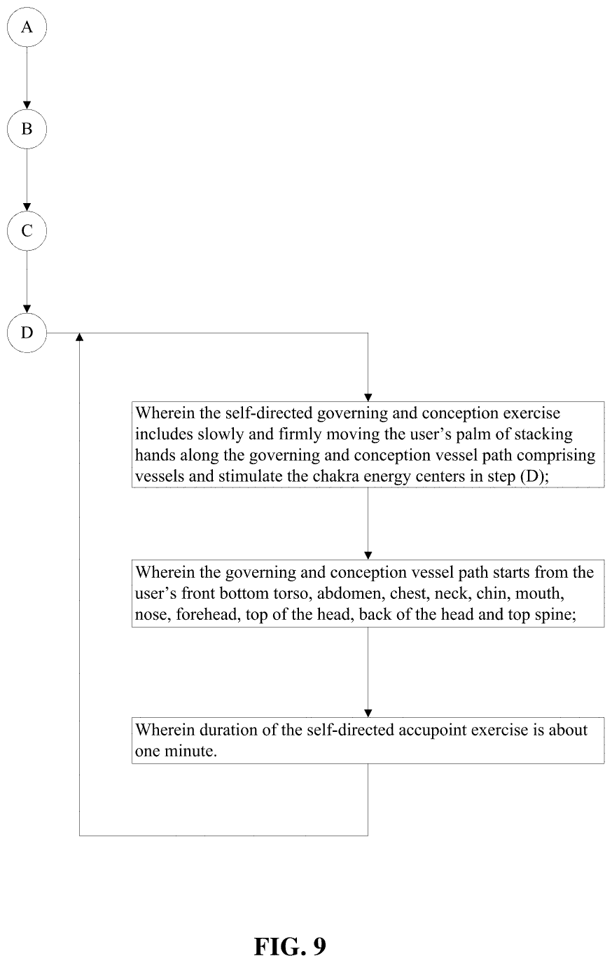

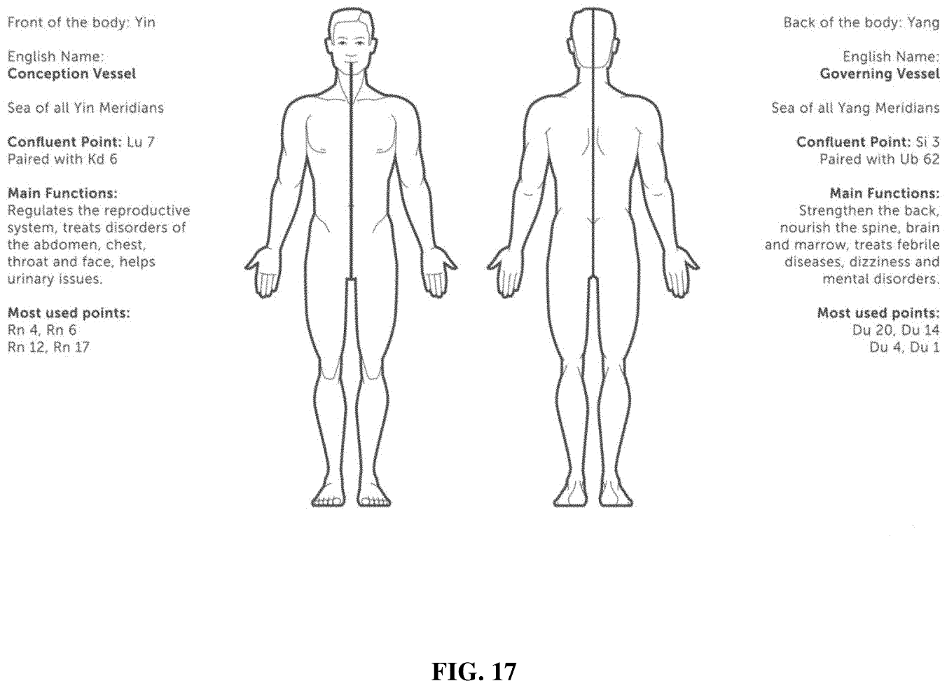

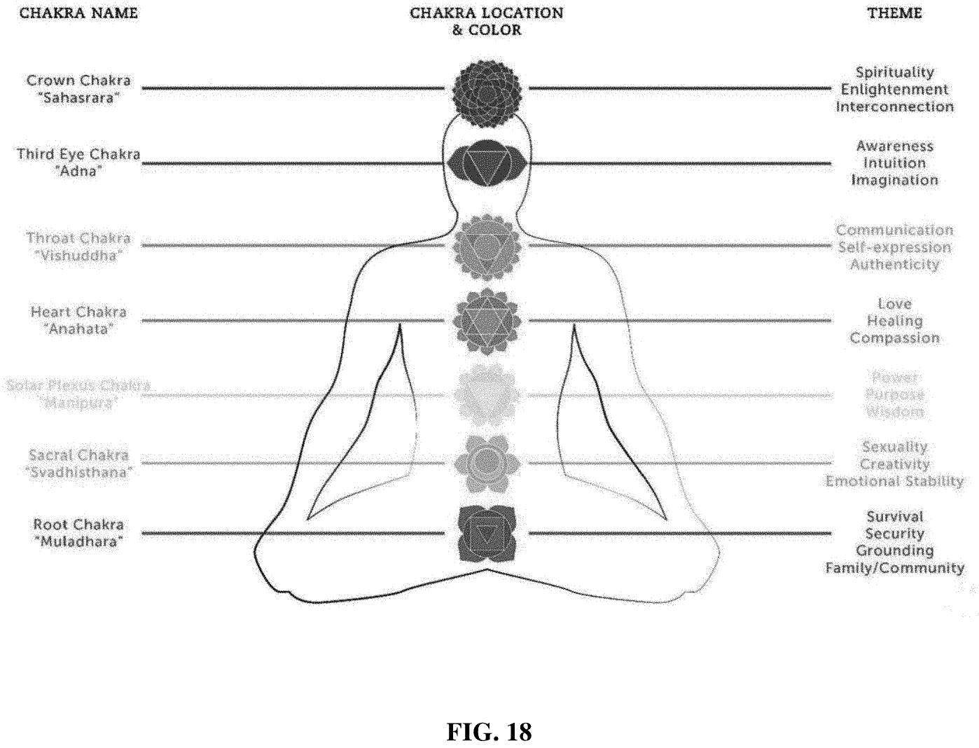

As can be seen in FIG. 9, the trilogy method of the present invention provides a sub-process to the user for facilitating the self-directed governing and conception exercise. More specifically, the trilogy method enables the user to slowly and firmly move the user's palm of stacking hands along the governing and conception vessel path comprising vessels and stimulate the plurality of chakra energy centers in Step D, wherein the governing and conception vessel path starts from the user's front bottom torso, abdomen, chest, neck, chin, mouth, nose, forehead, top of the head, back of the head and top spine, and wherein duration of the self-directed accupoint exercise is about one minute. Thus, this sub-process addresses governing and conception vessels such that the user can activate the governing and conception vessels in clearing blockages associated with chakra energy centers along the path of governing and conception vessels, as seen in FIG. 17 and FIG. 18.

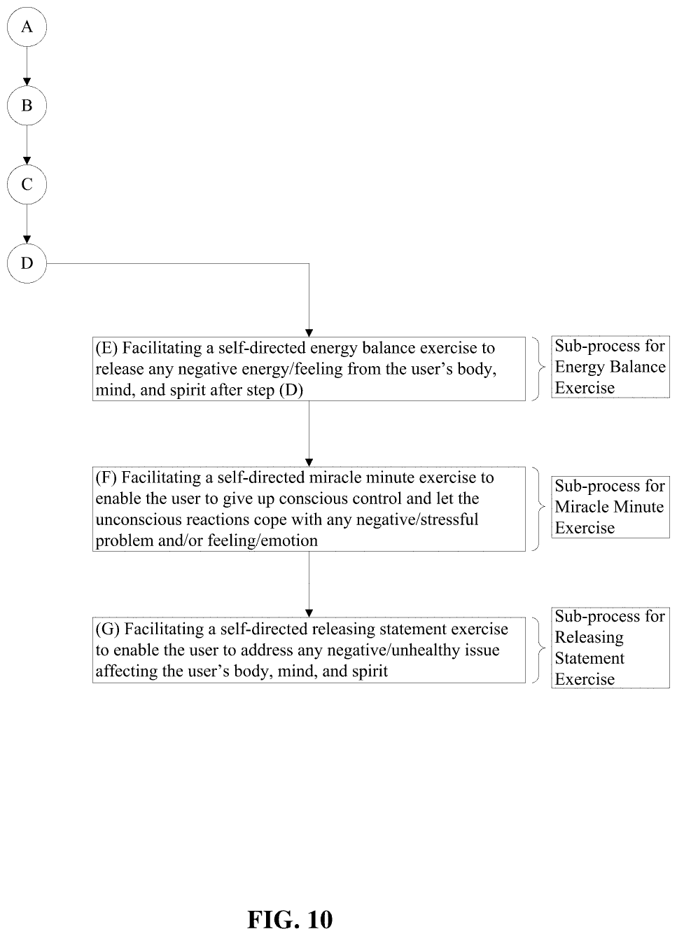

As can be seen in FIG. 10, in another embodiment of the present invention, the trilogy method provides sub-processes to the user for performing additional exercises. More specifically, the trilogy method facilitates a self-directed energy balance exercise to release any negative energy/feeling from the user's body, mind, and spirit after (Step E). Subsequently, the trilogy method facilitates a self-directed miracle minute exercise to enable the user to give up conscious control and let the unconscious reactions cope with any negative/stressful problem and/or feeling/emotion (Step F). Further, the trilogy method facilitates a self-directed releasing statement exercise to enable the user to address any negative/unhealthy issue affecting the user's body, mind, and spirit (Step G).

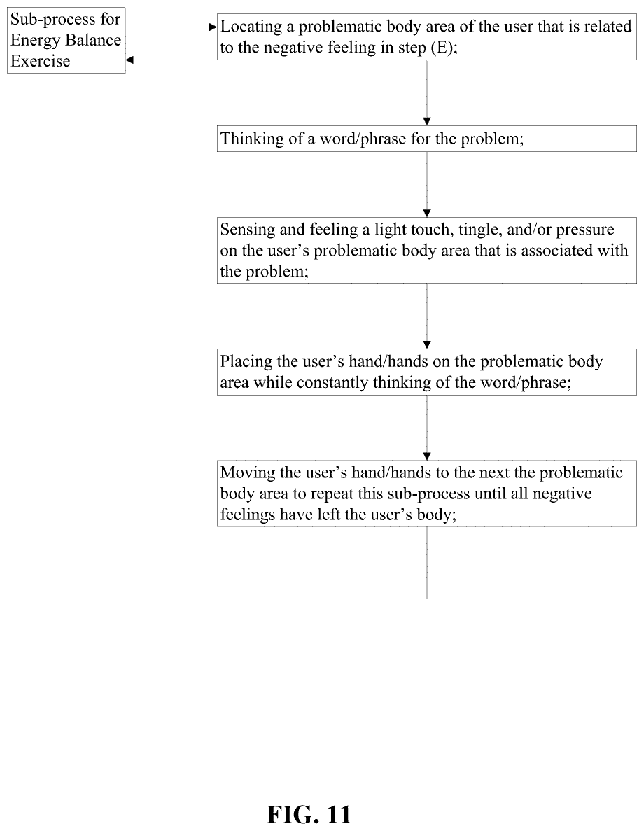

As can be seen in FIG. 11, the trilogy method of the present invention provides a sub-process to the user for facilitating the self-directed energy balance exercise. More specifically, the trilogy method enables the user to locate a problematic body area of the user that is related to the negative feeling in Step E and think of a word/phrase for the problem. While sensing and feeling a light touch, tingle, and/or pressure on the user's problematic body area that is associated with the problem, the user then places the user's hand/hands on the problematic body area while constantly thinking of the word/phrase, and moves the user's hand/hands to the next the problematic body area to repeat this sub-process until all negative feelings have left the user's body. This sub-process requires the user to think of a problem and a word for the problem. The user will then need to sense the problem as a light touch, tingle, and/or weight on any area on the user's body. The user will then put their hand there on the problem area, where both hands may be used for multiple places. The user will then keep thinking about the problem and the word for the problem. Subsequently, the user can discontinue bodily contact of the affected area when the user quits feeling the problem there and start feeling the problem somewhere else of the user's body. This process is repeated until the feeling has completely left the user's body.

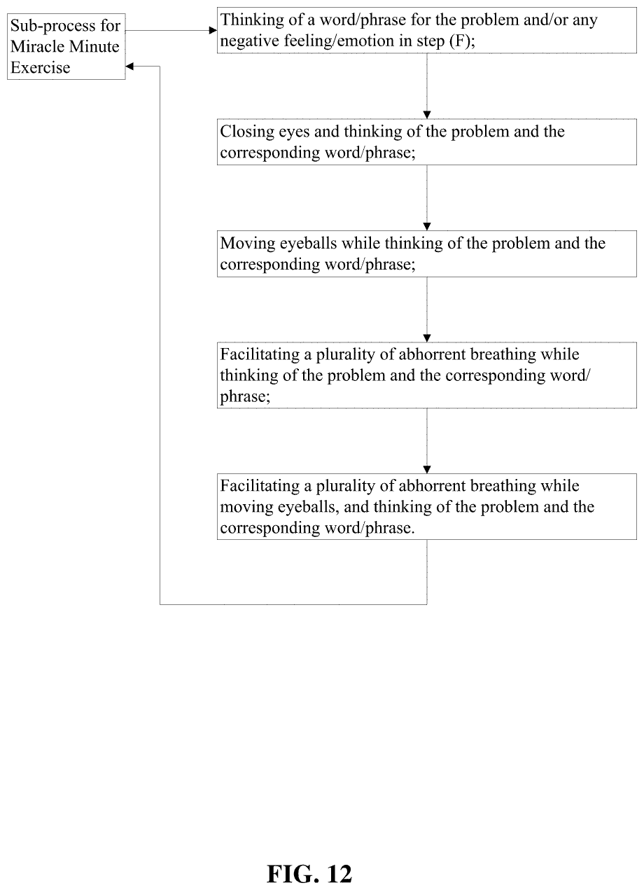

As can be seen in FIG. 12, the trilogy method of the present invention provides a sub-process to the user for facilitating the self-directed miracle minute exercise. More specifically, the trilogy method enables the user to think of a word/phrase for the problem and/or any negative feeling/emotion in Step F, and close eyes and think of the problem and the corresponding word/phrase. Immediately, the trilogy method facilities the user to move eyeballs while thinking of the problem and the corresponding word/phrase and perform a plurality of abhorrent breathing while thinking of the problem and the corresponding word/phrase. Subsequently, the trilogy method facilitates a plurality of abhorrent breathing while moving eyeballs and thinking of the problem and the corresponding word/phrase. In other embodiments of the present invention, the trilogy method may comprise other combinations of rapid eye movement exercises and abhorrent breathing exercises to enable the user to give up conscious control and let the unconscious reactions cope with the situation.

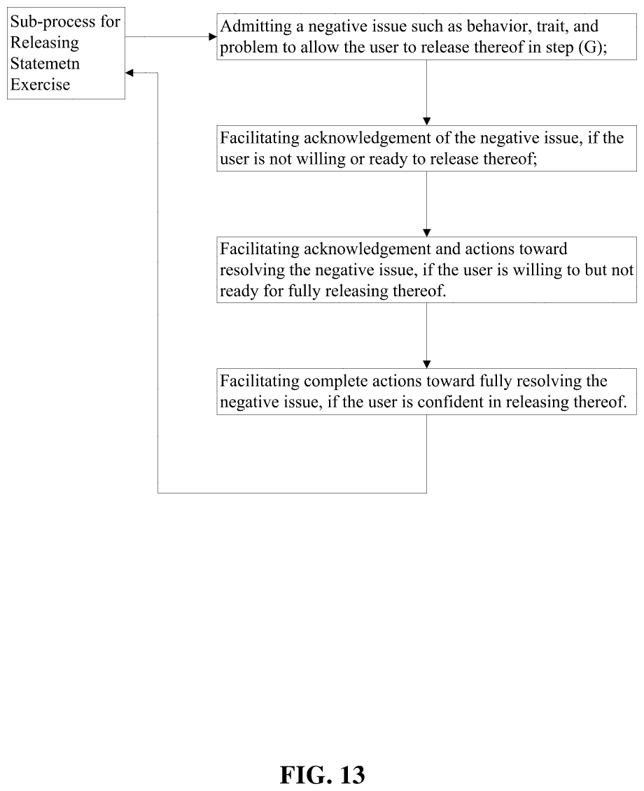

As can be seen in FIG. 13, the trilogy method of the present invention provides a sub-process to the user for facilitating the self-directed releasing statement exercise. More specifically, the trilogy method enables the user to admit a negative issue such as behavior, trait, and problem to allow the user to release thereof in Step G, and facilitate acknowledgement of the negative issue, if the user is not willing or ready to release thereof. Additionally, the trilogy method facilities acknowledgement and actions toward resolving the negative issue, if the user is willing to but not ready for fully releasing thereof. Further, the trilogy method facilities complete actions toward fully resolving the negative issue, if the user is confident in releasing thereof. In the releasing statement exercise sub-process, the admittance begins with the releasing statement. More specifically, the admittance allows the user to perform a self-directed admittance to release negative issues including, but not limited to, behaviors, traits, and problems. The acknowledgement of negative issues allows the user to further realize and resolve negative entities. After the admittance, the sub-process of the trilogy method first addresses the situation under which the user is not willing to release negative issues but acknowledge them as such. The trilogy method allows the user to take the right step in determining what is right and what is wrong. Additionally, the trilogy method addresses the situation under which the user is not willing to resolve negative issues but willing to make steps in to resolving them later. This allows the user to leverage an effort to correct their negative entities. Further, the trilogy addresses the situation under which the user is ready and confident to release negative issues. In the preferred embodiment of the present invention, the release statement may be conducted at the start of each trilogy process until the user fully resolves the negative issue and achieves the complete releasing statement.

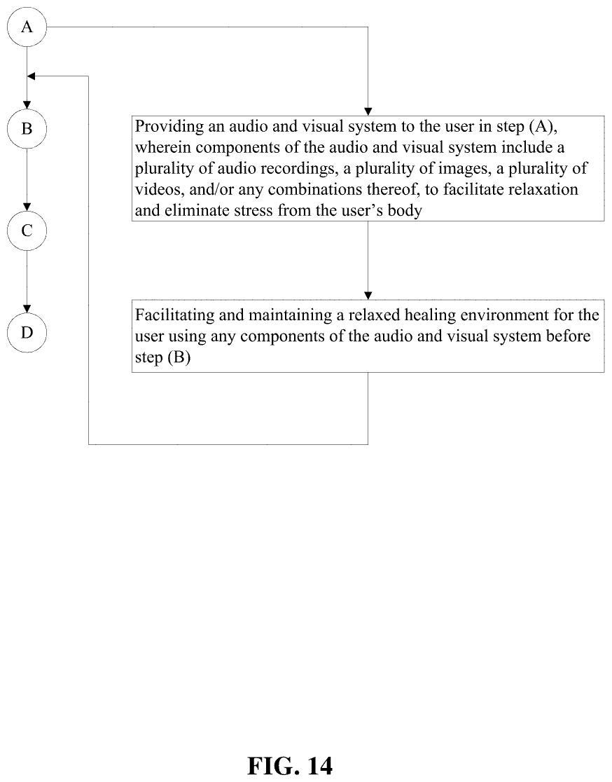

As can be seen in FIG. 14, the trilogy method of the present invention provides a sub-process of the trilogy method for providing and maintaining a relaxed healing environment using an audio and visual system of the present invention. More specifically, the trilogy method provides an audio and visual system to the user in Step A, wherein components of the audio and visual system include a plurality of audio recordings, a plurality of images, a plurality of videos, and/or any combinations thereof, to facilitate relaxation and eliminate stress from the user's body. Using the audio and visual system before performing the present invention, the trilogy method facilities and maintains a relaxed healing environment for the user using any components of the audio and visual system before Step B. This environment is beneficial to the user even during learning and/or coaching others the present invention. In general, through various combinations of components of the audio and visual system, the present invention can enable the user to facilitate relaxation and eliminate stress from the user's body whether performing a specific healing exercise including, but not limited to, trilogy, meditation, yoga, tai chi, Quantum Touch®, EFT, TFT, Reiki, acupuncture, etc.

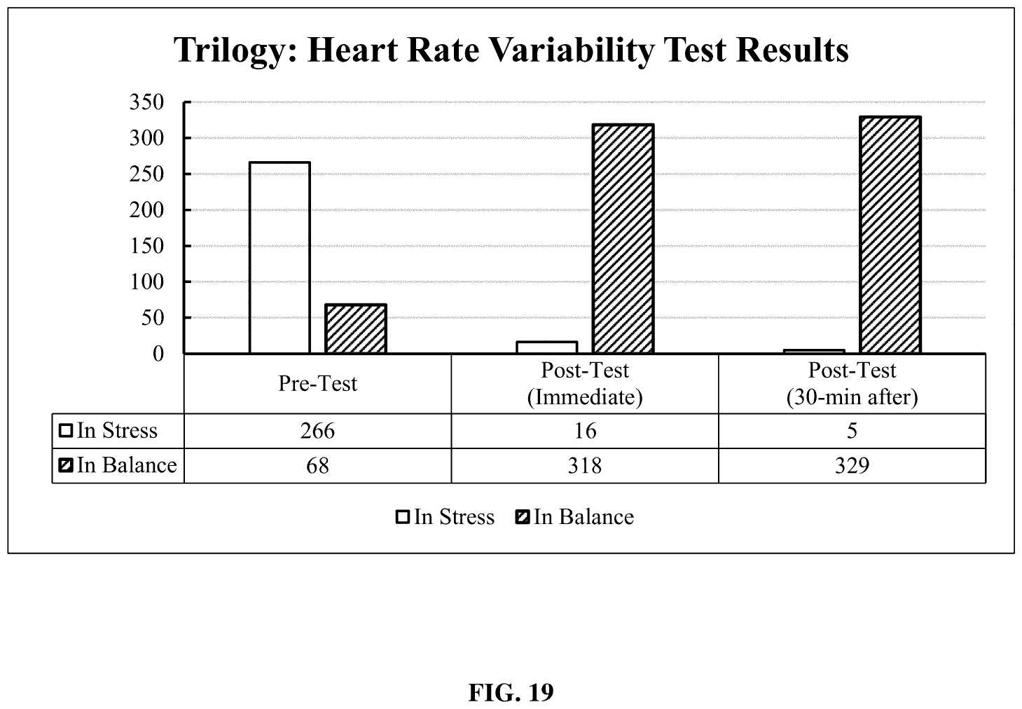

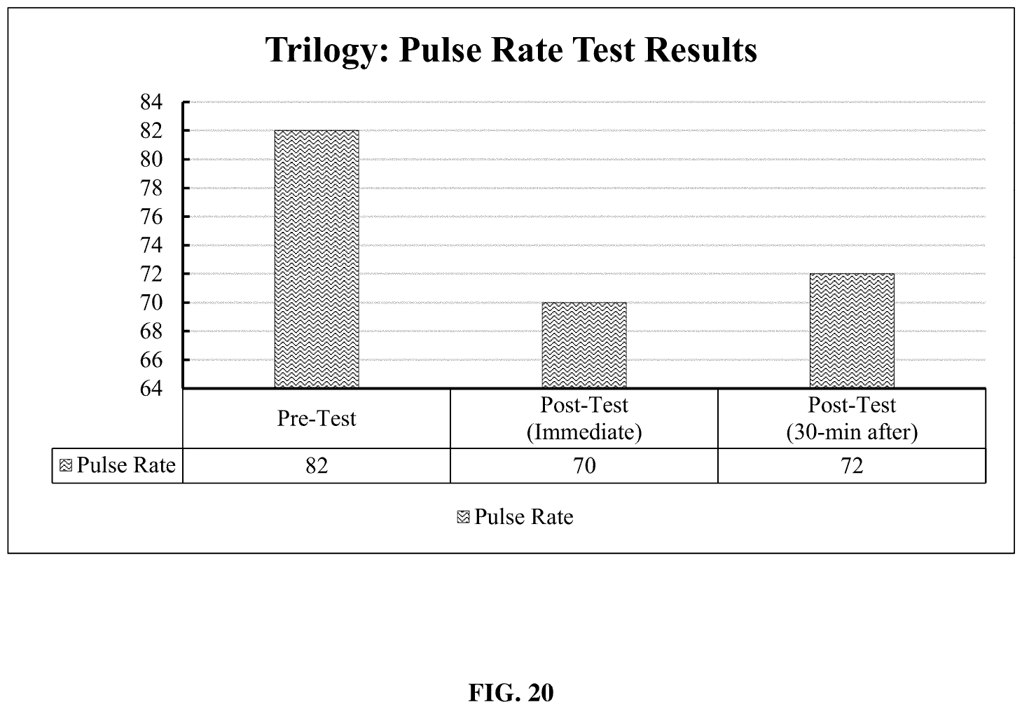

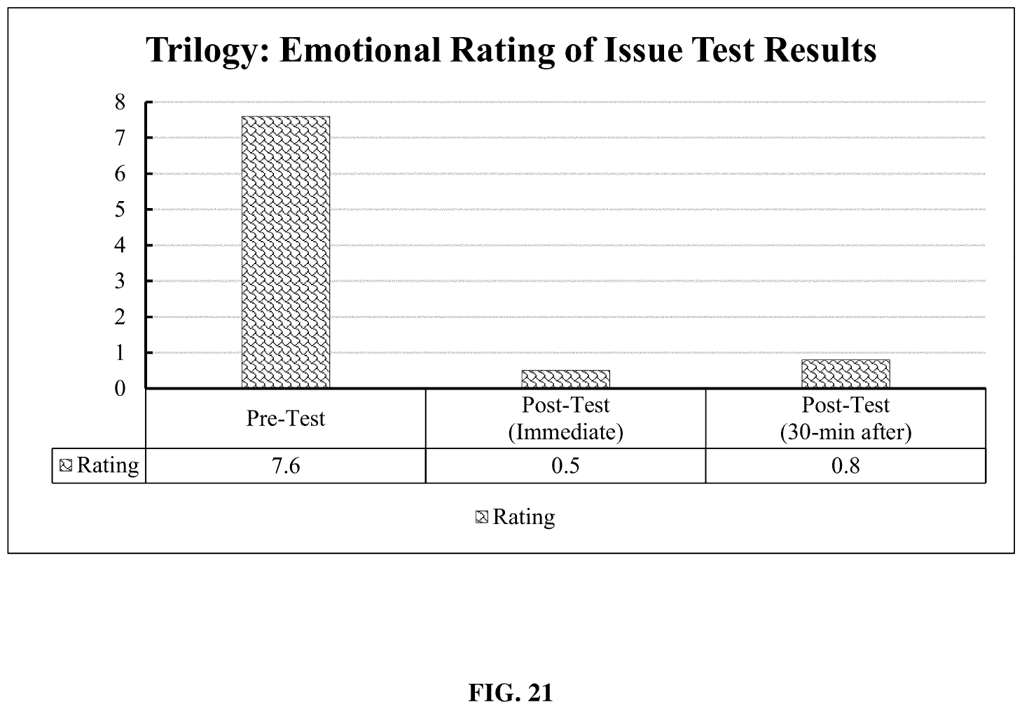

The trilogy method of the present invention has been gone through rigorous research and testing. Through a 2-year study between 2016 to 2017, 334 total individuals participated in 11 separate groups were tested and the results can be seen in FIG. 19 to FIG. 21. A heart rate variability (HRV) is a measure of the time between heartbeats of an individual. A high HRV represents high variability, meaning that the times vary greatly, while a low HRV represents very consistent intervals. As can be seen in FIG. 19, of the 266 tested individuals that were in stress before starting the trilogy process, only five (5) were still in stress when tested 30 minutes following the trilogy process. This is a 98% reduction due to participating in the trilogy process of the present invention. Similarly, a 383% increase in those that were in balance after the trilogy process. Pulse rate is an indicator of stress. As can be seen in FIG. 20, trilogy process proved to decrease the pulse rate in participants by an average of 12%. Further, the 2-year study conducted an emotional rating test. Prior to beginning the test, participants were asked to rate the problem they were addressing with trilogy method on a scale of 1-10 with 10 being the worse emotional rating which means that the participant is having the worst emotional issue(s) of his or her life. As can be seen in FIG. 21, the trilogy process brought a dramatic reduction of participants' emotional issues. Prior to the test, participants rated their issues as an average of 7.6. By the end of the test, the average rating was reduced by over 90%. Only nine (9) participants rated their issue as being greater than 1, among whom, seven (7) stated that their emotional charge was gone but still found the issue bothering them intellectually. The remaining two (2) stated that the issue no longer bothered them non-physically but did bother them physically. All acknowledged a significant decrease in the effect of emotional issues.

Although the invention has been explained in relation to its preferred embodiment, it is to be understood that many other possible modifications and variations can be made without departing from the spirit and scope of the invention as hereinafter claimed.

What is claimed is:

1. A method for self-directed energy healing of a user's mind, body, and spirit to release stress and negative issues, comprising the steps of:
(A) Providing a user with a stimulation system, which includes a plurality of accupoints, a plurality of healing code points, a plurality of governing and conception vessel paths, and a plurality of chakra energy centers to promote healthy circulation of the user's body, mind, and spirit;
(B) Facilitating a self-directed accupoint exercise to enable a user's blood, lymphatic, and energy circulatory systems moving freely;
(C) Facilitating a self-directed healing code point exercise to address the user's unconscious, sub-conscious, and/or conscious memory;
(D) Providing a self-directed governing and conception exercise to activate the user's governing and conception vessels and stimulate the chakras energy centers.

2. The method for self-directed energy healing of a user's mind, body, and spirit to release stress and negative issues as claimed in claim 1, comprising the steps of:
stimulating with at least one prayer the user's mindset into believing that all blockages and reversals in energy of circulatory system will be completely healed before step (B); and
wherein the light and love energy flows to every cell/organ/system of the user's body.

3. The method for self-directed energy healing of a user's mind, body, and spirit to release stress and negative issues as claimed in claim 1, comprising the steps of:
stimulating with at least one prayer the user's mindset into believing that unpleasant and unhealthy memories will be transformed into neutral and/or love memories before step (C); and
wherein the unpleasant and unhealthy memories are all fear-based generational, unconscious, subconscious, and/or conscious memories.

4. The method for self-directed energy healing of a user's mind, body, and spirit to release stress and negative issues as claimed in claim 1, comprising the steps of:
stimulating with at least one prayer the user's mindset into believing that the user's river of energy will be a bountiful river of love energy before step (D);
wherein the user's river of love energy feeds all meridians and points with love so that there is no room for fear; and
wherein the user's vortexes of energy will be open and free, and full of light and love.

5. The method for self-directed energy healing of a user's mind, body, and spirit to release stress and negative issues as claimed in claim 1, comprising the steps of:
wherein the self-directed accupoint exercise includes tapping the eyebrows, temples, regions under the chin, collar bone, sore spots, underarms, thymus, and any other areas of the user's body in step (B); and
wherein the duration of the self-directed accupoint exercise is about one minute.

6. The method for self-directed energy healing of a user's mind, body, and spirit to release stress and negative issues as claimed in claim 1, comprising the steps of:
placing the user's left palm on the brain stem and the right palm on the high bridge while performing a plurality of deep breath in step (C);
placing the user's right palm on the brain stem and the left palm on the high bridge while performing a plurality of deep breath; and
wherein duration of the self-directed healing code point exercise is about one minute.

7. The method for self-directed energy healing of a user's mind, body, and spirit to release stress and negative issues as claimed in claim 1, comprising the steps of:
stimulating the user's bridge with the user's fingers/hand by tapping, exerting pressure, or pointing the user's fingers/hand two to three inches away in step (C);
stimulating the user's Adam's Apple;
stimulating the user's jaws;
stimulating the user's temple;
placing the user's left palm on the brain stem and the right palm on the high bridge while performing a plurality of deep breath;
placing the user's right palm on the brain stem and the left palm on the high bridge while performing a plurality of deep breath; and
placing the user's hand/hands on the user's belly button.

8. The method for self-directed energy healing of a user's mind, body, and spirit to release stress and negative issues as claimed in claim 1, comprising the steps of:
wherein the self-directed governing and conception exercise includes slowly and firmly moving the user's palm of stacking hands along the governing and conception vessel path comprising vessels and stimulate the chakras energy centers in step (D);
wherein the governing and conception vessel path starts from the user's front bottom torso, abdomen, chest, neck, chin, mouth, nose, forehead, top of the head, back of the head and top spine; and
wherein duration of the self-directed accupoint exercise is about one minute.

9. The method for self-directed energy healing of a user's mind, body, and spirit to release stress and negative issues as claimed in claim 1, comprising the steps of:
(E) Facilitating a self-directed energy balance exercise to release any negative energy/feeling from the user's body, mind, and spirit after step (D);
(F) Facilitating a self-directed miracle minute exercise to enable the user to give up conscious control and let the unconscious reactions cope with any negative/stressful problem and/or feeling/emotion;
(G) Facilitating a self-directed releasing statement exercise to enable the user to address any negative/unhealthy issue affecting the user's body, mind, and spirit.

10. The method for self-directed energy healing of a user's mind, body, and spirit to release stress and negative issues as claimed in claim 9, comprising the steps of:
locating a problematic body area of the user that is related to the negative feeling in step (E);
thinking of a word/phrase for the problem;
sensing and feeling a light touch, tingle, and/or pressure on the user's problematic body area that is associated with the problem;
placing the user's hand/hands on the problematic body area while constantly thinking of the word/phrase; and
moving the user's hand/hands to the next the problematic body area to repeat this sub-process until all negative feelings have left the user's body.

11. The method for self-directed energy healing of a user's mind, body, and spirit to release stress and negative issues as claimed in claim 9, comprising the steps of:
thinking of a word/phrase for the problem and/or any negative feeling/emotion in step (F);
closing eyes and thinking of the problem and the corresponding word/phrase;
moving eyeballs while thinking of the problem and the corresponding word/phrase;
facilitating a plurality of abhorrent breathing while thinking of the problem and the corresponding word/phrase; and
facilitating a plurality of abhorrent breathing while moving eyeballs, and thinking of the problem and the corresponding word/phrase.

12. The method for self-directed energy healing of a user's mind, body, and spirit to release stress and negative issues as claimed in claim 9, comprising the steps of:
admitting a negative issue such as behavior, trait, and problem to allow the user to release thereof in step (G);
facilitating acknowledgement of the negative issue, if the user is not willing or ready to release thereof;
facilitating acknowledgement and actions toward resolving the negative issue, if the user is willing to but not ready for fully releasing thereof; and
facilitating complete actions toward fully resolving the negative issue, if the user is confident in releasing thereof.

13. The method for self-directed energy healing of a user's mind, body, and spirit to release stress and negative issues as claimed in claim 1, comprising the steps of:
providing an audio and visual system to the user in step (A), wherein components of the audio and visual system include a plurality of audio recordings, a plurality of images, a plurality of videos, and/or any combinations thereof, to facilitate relaxation and eliminate stress from the user's body; and
facilitating and maintaining a relaxed healing environment for the user using any components of the audio and visual system before step (B).

14. A method for self-directed energy healing of a user's mind, body, and spirit to release stress and negative issues, comprising the steps of:
(A) Providing a user with a stimulation system, which includes a plurality of accupoints, a plurality of healing code points, a plurality of governing and conception vessel paths, and a plurality of chakras energy centers to promote healthy circulation of the user's body, mind, and spirit;
(B) Facilitating a self-directed accupoint exercise to enable a user's blood, lymphatic, and energy circulatory systems moving freely;
(C) Facilitating a self-directed healing code point exercise to address the user's unconscious, sub-conscious, and/or conscious memory, wherein the self-directed healing code point exercise comprising the steps of:
placing the user's left palm on the brain stem and the right palm on the high bridge while performing a plurality of deep breath;
placing the user's right palm on the brain stem and the left palm on the high bridge while performing a plurality of deep breath;
wherein duration of the self-directed healing code point exercise is about one minute;
(D) Providing a self-directed governing and conception exercise to activate the user's governing and conception vessels and stimulate the chakras energy centers.

15. The method for self-directed energy healing of a user's mind, body, and spirit to release stress and negative issues as claimed in claim 14, comprising the steps of:
stimulating the user's bridge with the user's fingers/hand by tapping, exerting pressure, or pointing the user's fingers/hand two to three inches away in step (C);
stimulating the user's Adam's Apple;
stimulating the user's jaws;
stimulating the user's temple;
placing the user's left palm on the brain stem and the right palm on the high bridge while performing a plurality of deep breath;
placing the user's right palm on the brain stem and the left palm on the high bridge while performing a plurality of deep breath; and
placing the user's hand/hands on the user's belly button.

16. The method for self-directed energy healing of a user's mind, body, and spirit to release stress and negative issues as claimed in claim 14, comprising the steps of:
(E) Facilitating a self-directed energy balance exercise to release any negative energy/feeling from the user's body, mind, and spirit after step (D);
(F) Facilitating a self-directed miracle minute exercise to enable the user to give up conscious control and let the unconscious reactions cope with any negative/stressful problem and/or feeling/emotion;
(G) Facilitating a self-directed releasing statement exercise to enable the user to address any negative/unhealthy issue affecting the user's body, mind, and spirit.

17. The method for self-directed energy healing of a user's mind, body, and spirit to release stress and negative issues as claimed in claim 14, comprising the steps of:
providing an audio and visual system to the user in step (A), wherein components of the audio and visual system include a plurality of audio recordings, a plurality of images, a plurality of videos, and/or any combinations thereof, to facilitate relaxation and eliminate stress from the user's body; and
facilitating and maintaining a relaxed healing environment for the user using any components of the audio and visual system before step (B).

18. A method for self-directed energy healing of a user's mind, body, and spirit to release stress and negative issues, comprising the steps of:
(A) Providing a user with a stimulation system, which includes a plurality of accupoints, a plurality of healing code points, a plurality of governing and conception vessel paths, and a plurality of chakras energy centers to promote healthy circulation of the user's body, mind, and spirit;
(B) Facilitating a self-directed accupoint exercise to enable a user's blood, lymphatic, and energy circulatory systems moving freely;
(C) Facilitating a self-directed healing code point exercise to address the user's unconscious, sub-conscious, and/or conscious memory, wherein the self-directed healing code point exercise comprising the steps of:
placing the user's left palm on the brain stem and the right palm on the high bridge while performing a plurality of deep breath;
placing the user's right palm on the brain stem and the left palm on the high bridge while performing a plurality of deep breath;
wherein duration of the self-directed healing code point exercise is about one minute;
(D) Providing a self-directed governing and conception exercise to activate the user's governing and conception vessels and stimulate the chakras energy centers;
(E) Facilitating a self-directed energy balance exercise to release any negative energy/feeling from the user's body, mind, and spirit after step (D);
(F) Facilitating a self-directed miracle minute exercise to enable the user to give up conscious control and let the unconscious reactions cope with any negative/stressful problem and/or feeling/emotion;
(G) Facilitating a self-directed releasing statement exercise to enable the user to address any negative/unhealthy issue affecting the user's body, mind, and spirit.

19. The method for self-directed energy healing of a user's mind, body, and spirit to release stress and negative issues as claimed in claim 18, comprising the steps of:
stimulating the user's bridge with the user's fingers/hand by tapping, exerting pressure, or pointing the user's fingers/hand two to three inches away in step (C);
stimulating the user's Adam's Apple;
stimulating the user's jaws;
stimulating the user's temple;
placing the user's left palm on the brain stem and the right palm on the high bridge while performing a plurality of deep breath;
placing the user's right palm on the brain stem and the left palm on the high bridge while performing a plurality of deep breath; and
placing the user's hand/hands on the user's belly button.

20. The method for self-directed energy healing of a user's mind, body, and spirit to release stress and negative issues as claimed in claim 18, comprising the steps of:
providing an audio and visual system to the user in step (A), wherein components of the audio and visual system include a plurality of audio recordings, a plurality of images, a plurality of videos, and/or any combinations thereof, to facilitate relaxation and eliminate stress from the user's body; and
facilitating and maintaining a relaxed healing environment for the user using any components of the audio and visual system before step (B).
